(19) United States
(12) Patent Application Publication
(10) Pub. No.: US 2010/0149338 A1
(43) Pub. Date: Jun. 17, 2010

(54) Method and apparatus for multi-user user-specific scene visualization

(75) Inventors: Manoj Aggarwal, Lawrenceville, NJ (US); Vijay Ganti, West Windsor, NJ (US)

Correspondence Address: Mamigo Inc, 1 Flanigan St., Lawrenceville, NJ, 08648, US

(73) Assignee: MAMIGO INC, Lawrenceville, NJ (US)

(21) Appl. No.: 12/639,985

(22) Filed: Dec. 16, 2009

Related U.S. Application Data
(60) Provisional application No. 61/122,847, filed on Dec. 16, 2008.

(51) Int. Cl. H04N 7/18; H04N 5/232

(52) U.S. Cl. 348/159; 348/211.99; 348/E07.085; 348/E05.042

(57) ABSTRACT

A method and apparatus is described for providing a personalized interactive experience to view a scene to a plurality of concurrent users. A plurality of image sources with different attributes such as frame-rate and resolution, are digitally processed to provide controllable enhanced user-specific visualization. An image source control method is also described to adjust the image sources based on collective requirement of a plurality of users.

### CROSS-REFERENCE TO RELATED APPLICATIONS

This application claims benefit of U.S. provisional patent application Ser. No. 61/122,847, filed Dec. 16, 2008 which is incorporated herein as reference.

### BACKGROUND OF THE INVENTION

1. Field of the Invention

The present invention relates to a method and apparatus for providing a personalized interactive experience to view a scene with a plurality of concurrent users and, more specifically, controlling and digitally processing a plurality of image sources with different quality characteristics to synthesize user-specific views.

2. Description of the Related Art

Standard interactive systems limit the number of concurrent users. For example, Pan-tilt-zoom (PTZ) cameras have been used to provide users with a method to provide detailed surveillance or tracking in a wide-area surveillance scenario. These devices are normally managed by a single user at a time and sharing of the resource is not done or sharing is based on a priority system. Contention between stakeholders for access to the PTZ resource is common. Typically, a complex access-control system needs to be put in place to ensure no two users access the same PTZ at the same time. This is very limiting for multiple users who may have interest in monitoring a public facility for different reasons. In a typical security and surveillance scenario, a user may be the control center operator, senior security manager, and the responding guard, each with their own unique requirements when accessing the monitored space. In a military scenario, video from a surveillance resource such as an Unmanned Aerial Vehicle (UAV) payload may be required by the commander, intelligence officer, targeting and effects, and operations officer—again each with their own specific use cases.

This problem is especially relevant in a modern security climate where surveillance infrastructure is only as good as the eyes looking at their feeds. It is becoming increasingly important to allow more users to look at the video from these surveillance feeds. Often these users may be volunteers that do not belong to any particular agency. In such a scenario, it is important that users have an independent ability to get a better visualization of the region of interest.

The domain of sports and entertainment presents similar constraints. In an entertainment environment, like covering a football game, the broadcaster negotiates with the stadium and league to position and manipulate the cameras to provide view angles to best cover the event, but also considerations for view of advertising signs and team logos is also a part of the camera location equation. The producer/director is presented with the camera views on screens in the production shelter and via controls the producer selects or directs the imagery that is broadcast to a wider audience. The end-point consumer does not have any control to access the video available at the event, create their own version of the view or have their own sense of the venue. The director pushes a single feed temporally sourced from multiple cameras. Zoom levels and switching to a different camera and thus a different view is also a choice made by the director.

A number of methods and systems apparatus have been disclosed in prior art to use a combination of wide area, low-resolution fixed imaging sources and narrow area, high-resolution adjustable imaging sources to provide higher resolution interactivity, but to a very limited number of users—typically one user. These methods do not scale to support multiple, concurrent users.

U.S. Pat. No. 6,215,519 describes a system and method for providing higher-resolution views of selected regions of interest within a lower-resolution, wide field of view, image of a scene. The number of interactive users is limited to the number of imaging devices with adjustable view settings (PTZ cameras) in the system.

U.S. Pat. No. 6,147,709 describes a method for overlaying higher-resolution imagery from a fixed set of regions-of-interest onto a lower-resolution, wide field of view, image of a scene, and providing spatial interactivity. Higher-resolution interactivity is, however, limited to only the selected regions of interest.

U.S. Pat. No. 7,522,186 describes a method and apparatus for overlaying imagery from multiple fixed cameras onto a 3D textured model of a scene. It also describes high-resolution selective assessment with PTZ cameras. The number of interactive users is limited to one user at a time. While these methods differ in coverage and approach, they limit the number of interactive users, as only one user at a time can adjust the view settings of one high-resolution imaging device.

US Patent Numbers 2004/023,963 A1, U.S. Pat. No. 5,396,583, U.S. Pat. No. 5,359,363, and U.S. Pat. No. 5,185,667, among others, describe methods to digitally compose multiple image sources for a scene and provide a user-selected cut-out of the view. The use of digital composition and digital selection of regions of interest overcomes the resource contention imposed by physical PTZ cameras. These methods, however, limit the amount of magnification possible due to image resolution constraints. The image resolution is constrained by capture, transmission and storage bandwidth, and impacts capture rate and hence visualization experience.

Consequently, there remains a need in the art for a scalable method and apparatus that supports a plurality of concurrent users and provides personalized control to each of the concurrent users for smooth, immersive navigation of the scene with support for large magnification ratios.

### BRIEF SUMMARY OF THE INVENTION

The primary objective of the present invention is to provide a scalable method and apparatus that addresses the challenges to provide a personalized, interactive viewing experience with virtual pan, tilt, zoom and change in viewing perspective controls to a plurality of concurrent users.

The first aspect of this invention regards a method and apparatus for combining a first set of low-resolution, high-frame rate image sources with a second set of high-resolution, low-frame rate image sources to generate a plurality of controllable views with support for high magnification and high frame rates, in accordance with preferred embodiment of the present invention. The apparatus comprises of the first and second set of image sources, a frame grabber for the image sources, a processor for building a mathematical model that encapsulates transformation of image characteristics from lower resolution to higher resolution image sources, a View Composer for generating imagery to user-specified field of view setting, a view control device for each of the plurality of users, and a super-resolution processor that leverages the resolution transformation model to adjust, if necessary, resolution of synthesized views to the user-specified view settings. A view setting includes specification of field of view, viewpoint, view angle, resolution and frame-rate. The use of digital means for view synthesis enables a plurality of users to concurrently control their respective view settings. Further, use of high-resolution imagery to up-sample output views enables high magnification ratios. A user can virtually pan, tilt, zoom and change perspective by manipulating the view settings.

The first set of image sources can be comprised of one or more video cameras with regular or fisheye lenses, a cluster of cameras digitally processed to achieve enhanced field of view, or a catadioptric camera for enhanced field of view; and combinations thereof. The first set of image sources can be configured to have a collective field of view larger or equal to the area of interest. Alternatively, they can be configured to cover different portions of the area of interest from one or more viewpoints. Note, a portion or the whole area of interest may be imaged from one or more viewpoints. Availability of a plurality of viewpoints enables a user to change perspective, in addition to virtual pan, tilt and zoom.

The second set of image sources can be comprised of one or more fixed megapixel video cameras. An example is a Prosilica GE4900 providing sixteen megapixels @3 Hz, with a lens that at least covers the entire area of interest. Another example, of a high-resolution, low-frame rate image source is a cluster of high-resolution megapixel video cameras, such as Prosilica GE4900, with high zoom lenses in a fixed configuration. Another example of a very high resolution but poor, frame-rate image source is a cluster of high-resolution cameras configured with high zoom lenses that periodically hop across the area of interest to cover the area in small portions. The second set of image sources can be configured to have a collective field of view larger or equal to area of interest. Alternatively, they can also be configured to cover different portions of the area of interest from one or more viewpoints. Note, a portion or the whole area of interest may be imaged from one or more viewpoints. Availability of a plurality of viewpoints enables a user to change perspective, in addition to virtual pan, tilt and zoom.

A second aspect of the invention regards a method for controlling the two sets of image sources based on collective requirement of the plurality of users. The method describes a Scan Pattern Generator. The Scan Pattern Generator, based on collective view requirements of the plurality of users adaptively determines scan pattern for the plurality of image sources. The scan pattern can comprise of a set of regions of interest with each region of interest optionally associated with recommended control attributes such as resolution and revisit rate. The Scan Pattern Generator serves the purpose of reducing the amount of transfer bandwidth required from the image sources to the frame grabber. Further, it can also enhance the effective frame rate for the imagery.

The Scan Pattern Generator, in its simplest form, may be configured to compute a union of field of view requirements from each of the plurality of users to generate one or more regions of interest. Such regions of interest may be overlapping. The Scan Pattern Generator may be further configured to first evaluate which of the plurality of view requirements can be met with imagery from the first set of low-resolution image sources, and which require imagery from the second set of high-resolution image sources. For example, if a user requires wide-angle view of the scene with resolution less than or equal to that of the first set of image sources, then that requirement for that user can be met without need for additional high-resolution imagery.

It can be further configured to determine both regions of interest and associated resolution attributes at which the regions of interest must be acquired. For example, if a user requires a field of view corresponding to 1K×1K of high-resolution imagery but only at 256×256 pixel output resolution, then the Scan Pattern Generator may specify that the region of interest is required with 4× resolution reduction along each axis.

It can be further configured to determine regions of interest and an associated revisit rate control attribute for each region of interest. For example, if a user is not actively modifying their view or if the view does not have any dynamic action, the Scan Pattern Generator can include logic to reduce re-visit rates for such regions-of-interest, while increasing revisit rates for other areas with more dynamic action or user activity. Further, the Scan Pattern Generator can be configured to determine a set of regions of interest with both revisit rate and resolution attributes associated with each region of interest.

A third aspect of the invention regards a method for combining the first set of high-frame rate image sources with the second set of low-frame rate image sources to generate a plurality of controllable views with support for consistent and high-frame rates across the area of interest, in accordance with an embodiment of the present invention. Further details of the present invention will be understood from reading the detailed description of the invention which follows and by studying the accompanying drawings.

### BRIEF DESCRIPTION OF THE SEVERAL VIEWS OF THE DRAWING

FIG. 1 is a block diagram illustrating the main components utilized by the method and apparatus for synthesizing a plurality of user-controlled views, in accordance with preferred embodiment of the present invention.

FIG. 2 is a detailed block diagram illustrating an exemplary method for combining first set of low resolution, high-frame rate image sources with second set of high-resolution, low-frame rate image sources to generate a controllable view with support for high magnification and high frame rates, in accordance with preferred embodiment of the present invention.

FIG. 3 is a detailed block diagram illustrating an alternate method for combining first set of low-resolution, high-frame rate image sources with second set of high resolution, low-frame rate image sources to generate a controllable view with support for high magnification and high frame rates, in accordance with an embodiment of the present invention.

FIG. 4 is a detailed block diagram illustrating an exemplary method for combining first set of high-frame rate image sources with second set of low-frame rate image sources to generate a controllable view with support for high frame rates across the entire area of interest, in accordance with an embodiment of the present invention.

FIG. 5 is a detailed block diagram illustrating an exemplary method for adaptively determining a scan pattern for the plurality of image sources based on plurality of view specifications from a plurality of users.

FIG. 6-8 are graphic representations illustrating exemplary behavior of exemplary configurations of Scan Pattern Generator.

### DETAILED DESCRIPTION OF THE INVENTION

The present invention relates to a method and apparatus for providing a personalized, interactive experience of viewing a scene to a plurality of concurrent users. The key aspects of this invention relate to digitally synthesizing user-controllable views of a scene with a large magnification range using a combination of the first set of high rate, low-resolution image sources and the second set of low rate, high-resolution image sources, adaptively controlling the set of image sources and supporting a plurality of concurrent interactive users.

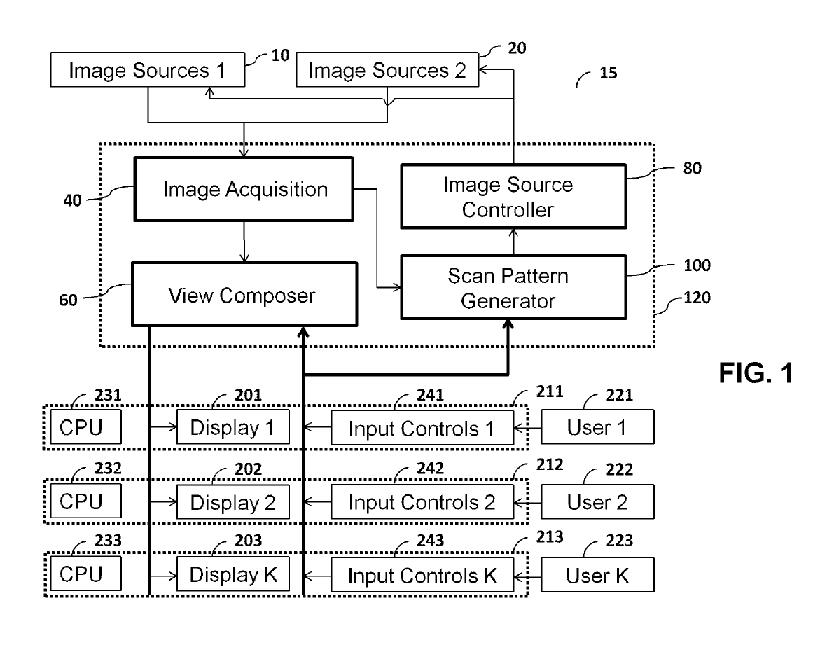

FIG. 1 is a block diagram illustrating the main components utilized by the method and apparatus for synthesizing a plurality of user-controlled views, in accordance with preferred embodiments of the present invention. The system 15 includes first set of high-frame rate, low-resolution image sources 10, and second set of low-frame rate, high-resolution image sources 20. The adjectives “high” and “low” for frame rate are used in relative sense to indicate that Image Sources 20 have a lower effective frame rate for a scene location than for Image Sources 10. Similarly, the adjectives “high” and “low” for resolution are used in relative sense to indicate that Image Sources 20 have higher ground sampling distance (GSD) measured in pixels/unit area, for a scene location than for Image Sources 10. The resolution, frame-rate and GSD are also commonly referred to as the quality characteristics of an image source. Note, if two image sources have the same field of regard, then resolution and GSD are equivalent.

Image Sources 10 can be comprised of one or more number of image sources. An image source can be, but not limited to, a digital video camera, video file, recorded media with playback support, digitally mosaicked video imagery or combinations thereof. Image Sources 10 can be configured to have a collective field of view larger or equal to area-of-interest, and from one or more viewpoints. Alternatively, a subset of Image Sources 10 can be configured to cover a portion of the area of interest from one or more viewpoints, while another subset can be configured to cover another portion of the area of interest from other one or more viewpoints. The resolution and frame rate of Image Sources 10 are application specific.

Image Sources 20 comprises of one or more number of image sources. An image source can be, but not limited to, a digital video camera, video file, recorded media with playback support, digitally mosaicked video imagery, pan-tilt-zoom video camera, or combinations thereof. Image Sources 20 differ from Image Sources 10 in at least one of the quality characteristics. In the preferred embodiment, the resolution (or equivalently GSD, if Image Sources 10 and Images Sources 20 have similar field of view) of Image Sources 20 is higher than that of Image Sources 10 although their frame rate can be lower than that of Image Sources 10. An example configuration of Image Sources 20 is a single Prosilica GE4900, which provides 16-megapixels @3 Hz, with a lens that at least covers the entire area of interest. Another exemplary Image Sources 20 is a cluster of six Prosilica GE4900 video cameras with high zoom lenses in a fixed configuration with collective field of view larger than the area of interest. For example, for a football stadium, a cluster of six 16-megapixel cameras with field of view that covers at least the entire football field of 100×40 yards, provides enough resolution to zoom so that a player occupies the entire vertical length of a standard 640×480 resolution screen. This is an effective magnification of approximately 18×. Another exemplary configuration for Image Sources 20 is multiple clusters of six Prosilica GE4900 video cameras located at several locations to provide high-resolution imagery from multiple viewpoints. For example, for a sport football stadium, it is useful to have coverage from the viewpoint of the goal post and from the long-side of the field. Another example of very high resolution but poor frame rate Image Sources 20 is a single Prosilica GE4900 camera with high zoom lenses, and configured with a pan-tilt mechanism to periodically hop across the area of interest to cover each portion in high-resolution.

Image Sources 10 and 20 are connected to a programmable computing device 120 via communication interfaces such as coaxial cables, fiber channel, Ethernet, GigE, Firewire and Channelink cables. The specific communication interface depends upon the interfaces available on Image Sources 10 and 20, and Image Acquisition 40 device. For example, an IP-based image source will require standard 10/100 Ethernet interfaces, while a high-resolution Image Sources 20 such as a single Prosilica GE4900 provides GigE and ChannelLink interfaces. GigE interfaces are typically available on most modern computing devices, and if not, it can be readily supported on the Computing device 120 with a Gigabit Ethernet card such as D-link DGE-530T. The communication interface between Image Sources 10 and 20 and Computing device 120 can optionally include adapters to convert between incompatible interfaces, and transceivers such as a fiber transceiver to extend the distance between Image Sources 10 and 20 and Computing device 120.

The Computing device 120 can be a computing platform such as a server-grade computer or similar. Computing device 120 hosts Image Acquisition 40 peripheral and drivers for capturing imagery from the Image Sources 10 and 20, View Composer 60 for processing captured imagery and synthesis of a plurality of output video based on user control requests, and optional Scan Pattern Generator 100 for adaptively determining capture settings for Image Sources 20, and optional Image Source Controller 80 for configuring Image Sources 10 and 20 with the determined capture settings. Computing device 120 also hosts peripherals and drivers to interface with user devices 211, 212, and 213 for receiving view control requests and transmitting synthesized output. The interface between the Computing device 120 and the user devices 211, 212, and 213 can be wired-Ethernet, wireless radio interfaces, such as 802.11 or 802.16, cable/fiber/satellite network or short-length direct links such as USB, VGA, DVI, HDMI, or a combination thereof.

A plurality of users 221, 222 and 223 manipulate respective input controls 241, 242, and 243 on their respective user devices 211, 212, and 213 to submit view controls requests to the computing device 120 regarding modification of field of view, resolution, frame-rate, viewing angle and view point, and synthesis of output video corresponding to the specified view parameters. The users 221, 222 and 223 can visualize the synthesized output video received from Computing device 120 corresponding to their respective view control requests on respective display devices 201, 202 and 203. The display devices 201, 202 and 203 optionally can display additional controls and indicators to assist respective users 221, 222 and 223 to interact with system 15.

A user device among 211, 212, and 213 can be a personal desktop computer, a laptop, a handheld, a combo of TV, TV remote control and a setup-box, a handheld device such as a smart-phone or a cell-phone, a touch-screen LCD display, or a combination of an individual display device and input device with no programmable computing device. An individual input device can be a keyboard, joystick, touch-screen, or a pointing device, such as a pen, mouse or a trackball. An individual display device can be, but not limited to, a television screen, CRT monitor or desktop LCD display. The optional local computing devices 231, 232, and 233 interface respective input controls 241, 242, and 243, respective display devices 201, 202 and 203, within their respective 211, 212 and 213 user devices to provide an integrated interface to both the Computing device 120 and respective users 221, 222 and 223. In certain embodiments of the present invention, optional local computing devices 231, 232, and 233 can also host a portion of the processing performed by View Composer 60 to reduce processing load on computing device 120 and improve scalability of system 15.

In the preferred embodiment of the present invention, system 15 is utilized as the environment in which the proposed method and apparatus is operating. Image Sources 10 capture a plurality of video streams at low resolution but at high frame rate. Image Sources 20 capture a plurality of video streams at high resolution but may be at low frame rate. The plurality of video streams from Image Sources 10 and 20 are transmitted to computing device 120. The plurality of video streams is captured and electronically encoded by Image Acquisition 40 device. The imagery may be optionally stored for buffering or later retrieval in a storage device (not shown). The imagery is processed using View Composer 60.

The users 221, 222 and 223 manipulate their respective input controls 241, 242, and 243 to submit view control requests via their respective user devices 211, 212, and 213 to computing device 120 to synthesize views with specified view parameters such as view angle, resolution, field of view, viewpoint and frame-rate. View Composer 60 receives view control requests from a plurality of user devices 221, 222 and 223. View Composer 60 uses software means, or hardware, or combination thereof, to process and combine low resolution, high-frame rate imagery from Image Sources 10 with high resolution, low-frame rate imagery from Image Sources 20 to synthesize a plurality of output videos corresponding to each of view control requests. The synthesized imagery is subsequently transmitted to respective user display devices 201, 202 and 203 for visualization. This enables a plurality of users 221, 222 and 223 to dynamically and concurrently control a view of the scene. Further, higher magnification ratios up to the (high) resolution of the Image Sources 20 is achieved with (high)-frame rates of the low-resolution Image Sources 10.

The Computing device 120 optionally includes a Scan Pattern Generator 100 for adaptively determining the scan pattern for Image Sources 10 and 20 based on the collective view control requests and an optional Image Source Controller 80 for configuring Image Sources 20 with the determined scan pattern. It is explicitly clarified that View Composer 60 does not explicitly depend on Scan Pattern Generator 100 and Image Source Controller 80. View Composer 60 synthesizes a plurality of views with support for per view personalized virtual pan, tilt, zoom and change in view perspective, using image processing means by combining low and high resolution image sources. Scan Pattern Generator 100 and Image Source Controller 80 are optional. These components control the image data made available to View Composer 60. For example, they can reduce the amount of transfer bandwidth required from Image Sources 10 and 20 to the Computing device 120. Further, they can enhance the effective frame rate for the high-resolution imagery from Image Sources 20. These aspects of the invention are described in detail later in the section.

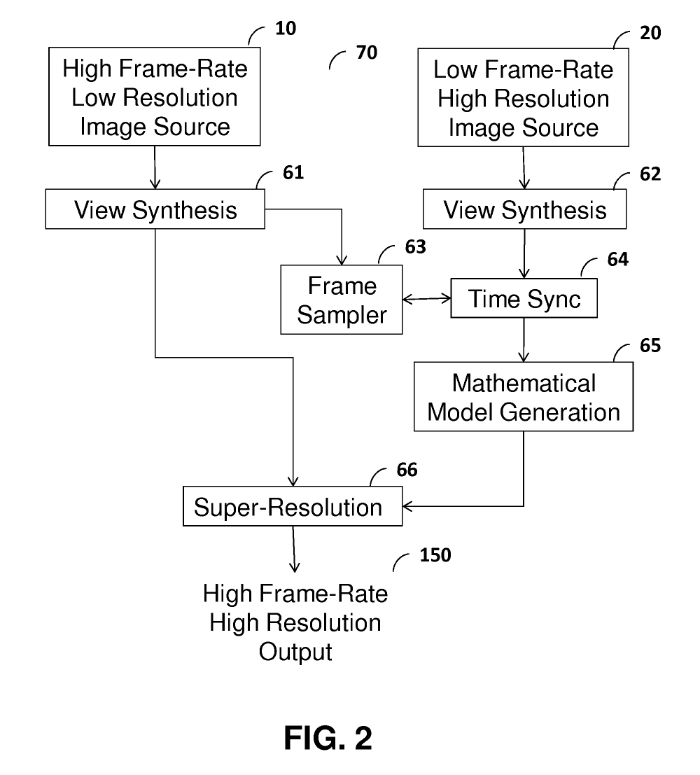

FIG. 2 is a detailed block diagram illustrating an exemplary method 70 that can be implemented in View Composer 60. It describes a method for combining first set of low resolution, high-frame rate image sources with second set of high resolution, low-frame rate image sources to generate a controllable view with support for high magnification and high frame rates, in accordance with preferred embodiment of the present invention. A number of main components, such as User devices, Image Acquisition, Scan Pattern Generator and Image Source Controller are not shown. Although, the figure shows one output video, those skilled in the art will appreciate that the view composition method 70 extends to synthesis of a plurality of independently controllable output views.

Low-resolution imagery from Image Sources 10 is processed by View Synthesis 61. View Synthesis 61 is operative in color correcting, geometrically transforming one or more images, followed by image fusion. Image fusion includes processes such as cut-and-paste, alpha blending, flow warping and similar processes for image synthesis. An exemplary approach for view synthesis is described in U.S. Pat. No. 6,075,905. The view parameters, such as view angle, field of view, resolution, frame rate and viewpoint, govern the behavior of View Synthesis 61. These parameters are used to select images and for each to compute the color correction, geometric transformation and image fusion parameters. Although, digital geometric transformations allow arbitrary magnification, image quality can degrade beyond the native resolution of the input data, without availability of any additional information about the scene. Thus, although the output of View Synthesis 61 provides flexibility in view angle, field of view, frame-rate and viewpoint, zoom magnification is limited to the native (low) resolution of the Image Sources 10. The frame rate of View Synthesis 61 output can be lower or comparable to the high-frame rate of Image Sources 10. Optionally, frame rate higher than native frame rate of Image Sources 10 can be achieved using temporal interpolation techniques as described in U.S. Pat. No. 7,586,540.

High-resolution imagery from Image Sources 20 is processed by View Synthesis 62. View Synthesis 62 is operative in similar processing as View Synthesis 61, with the exception that it operates on high-resolution imagery from Image Sources 20, and synthesizes high-resolution output imagery with output-frame rate lower or comparable to the low-frame rate of Image Sources 20. The high-resolution synthesized output video stream is sent to Time-Sync 64.

The output of View Synthesis 61 is sent to a Frame Sampler 63. The Frame Sampler 63 performs temporal down-sampling and in conjunction with a Time-Sync 64 component creates a pairing of approximately time-aligned frames from the low-resolution and high-resolution synthesized output video streams. Mathematical Model Generation 65 operates on a pair of such low-resolution and high-resolution image frames to build a mathematical model of transformation between low resolution and high-resolution imagery. Mathematical Model Generation 65, first, computes flow vectors between the two image pairs to generate a large set of corresponding pixel-patch pairs. Second, corresponding pixel-patch pairs are input to a learning stage which builds a mathematical model that can be used to infer from a low-resolution image patch what the most likely high-resolution patch would be. An exemplary mathematical model and learning process is described in U.S. Pat. No. 7,379,611. The Mathematical Model Generation 65 is periodically updated as new low-resolution and high-resolution image pairs are received.

The Super-Resolution 66 is operative in processing the low-resolution synthesized stream from View Synthesis 61 using the latest mathematical model from Mathematical Model Generation 65. A low-resolution image is tiled into small patches. For every such patch from the low-resolution synthesized image, the mathematical model is used to transform the low-resolution patch into a high-resolution patch. A collective approach such as Markov Random Field based inference as described in U.S. Pat. No. 7,379,611 can also be used to minimize seams between reconstructed patches. Since, the mathematical model is built using actual low-resolution and high-resolution imagery of substantially the same scene; the likelihood of finding a very similar patch in the learned mathematical model is substantially higher. As a result, the reconstruction quality of a high-resolution image is very high, compared to situations where the mathematical model is learned between low-resolution images and generic high-resolution images.

Thus, the output 150 of Super-Resolution 66 is a synthesized controllable video of the scene whose frame rate can be comparable to that of high-frame rate Image Sources 10, while its magnification can be controlled to have resolution comparable to that of high resolution Image Sources 20.

Consider an illustrative example. Let Image Sources 10 be a cluster of six co-located 640×480 resolution standard VGA resolution camcorders covering a football field with a frame rate of 30 Hz, and Image Sources 20 be a cluster of six co-located Prosilica GE4900 cameras providing a total resolution of ninety-six megapixels @3 Hz. Let the resolution of the user's display be 640×480. Using Image Sources 10 alone the user will be able to pan and tilt across the entire field, but the maximum magnification ratio will be comparable to sqrt(6), which is approximately equal to 2.5×. Using the present invention, the maximum magnification ratio achievable will be sqrt(96/(640×480), which is approximately equal to 18×, while retaining an output frame rate of 30 Hz and ability to pan and tilt across the football field.

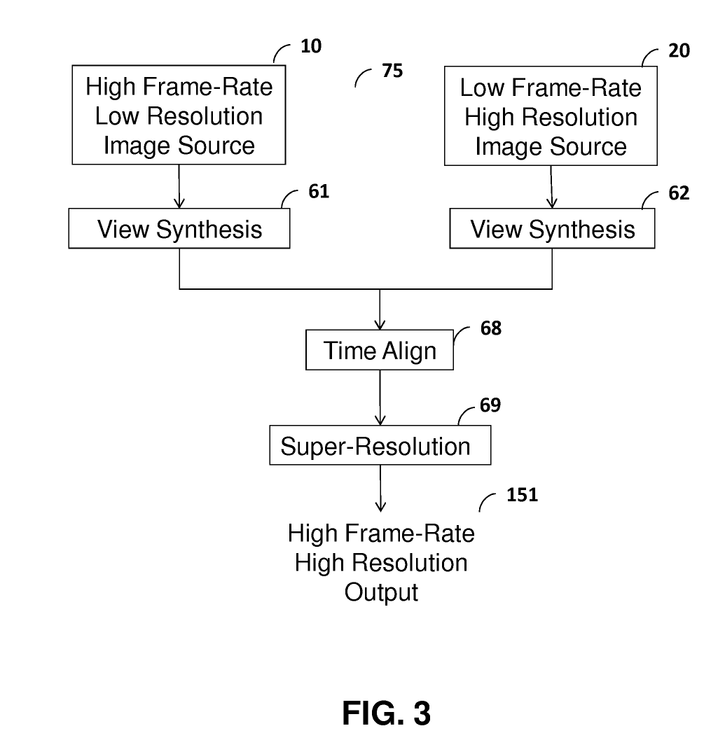

FIG. 3 is a detailed block diagram illustrating an alternate method 75 that can be implemented in View Composer 60. It describes a method for combining the first set of low resolution, high-frame rate image sources with the second set of high-resolution, low-frame rate image sources to generate a controllable view with support for high magnification and high frame rates, in accordance with an embodiment of the present invention. A number of main components, such as User devices, Image Acquisition, Scan Pattern Generator and Image Source Controller are not shown in the figure. Although, the figure shows one output video, those skilled in the art will appreciate that the method 75 of View Composer 60 extends to synthesis of a plurality of independently controllable output videos.

Similar to method 70, View Synthesis 61 and 62 respectively process imagery from respective Image Sources 10 and Image Sources 20 to synthesize respective low-resolution, high-frame rate intermediate streams and high resolution, low-frame rate intermediate streams. The two video streams are input to a Time Align 68 component which groups one or more high-resolution frames with every low-resolution frame. The grouping is done based on proximity in time of high-resolution frames to the low-resolution frame. A sequence of such frame groups is processed by a Super-Resolution 69 component. Super-Resolution 69 implements a flow based, super-resolution method similar to one described in U.S. Pat. No. 7,260,274, or the like. It aligns the one or more high-resolution frames to the low resolution frame in the group, warps and blends the one or more high-resolution frames with the low-resolution frame to synthesize a high-resolution composite 151. Thus, the output 151 of method 75 is a synthesized controllable video of the scene whose frame rate can be comparable to that of high frame rate Image Sources 10, while its magnification can be controlled to have resolution comparable to that of high resolution of Image Sources 20.

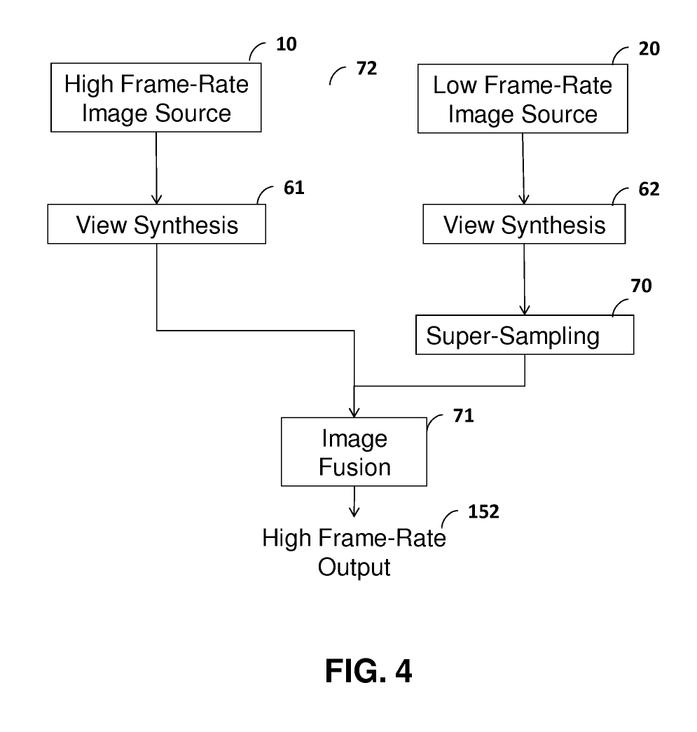

FIG. 4 is a detailed block diagram illustrating an exemplary method 72 that can be implemented in View Composer 60. It describes a method for combining first set of high-frame rate image sources with second set of low-frame rate image sources that collectively covers the entire area of interest to generate a controllable view with high-frame rates over the entire area of interest, in accordance with an embodiment of the present invention. A number of main components, such as User devices, Image Acquisition, Scan Pattern Generator and Image Source Controller are not shown in the figure. Although, the figure shows one output video, those skilled in the art will appreciate that the method 72 of View Composer 60 extends to synthesis of a plurality of independently controllable output videos.

Similar to method 75, View Synthesis 61 and 62 respectively process imagery from respective Image Sources 10 and Image Sources 20 to synthesize respective high-frame rate intermediate streams and low-frame rate intermediate streams. A view requirement may fall into three categories, first, the view may fall entirely within the field of view of the high-frame rate image sources 10, second, it may fall exclusively within the field of view of the low-frame rate image sources 20, and third, it may have a portion that exclusively belong Image Sources 10, and another portion that exclusively belong to Image Sources 20. For the first category, the output of View Synthesis 61 is the high-rate output view stream 152. For the second and third category, Super-Sampling 70 processes the output of View Synthesis 62 to adjust for frame rate using a temporal interpolation method such as described in U.S. Pat. No. 7,586,540. Image Fusion 71 time-synchronizes and operates on the output stream of View Synthesis 61 and frame rate enhanced-output stream of View Synthesis 62 to generate the high-frame rate output view stream 152.

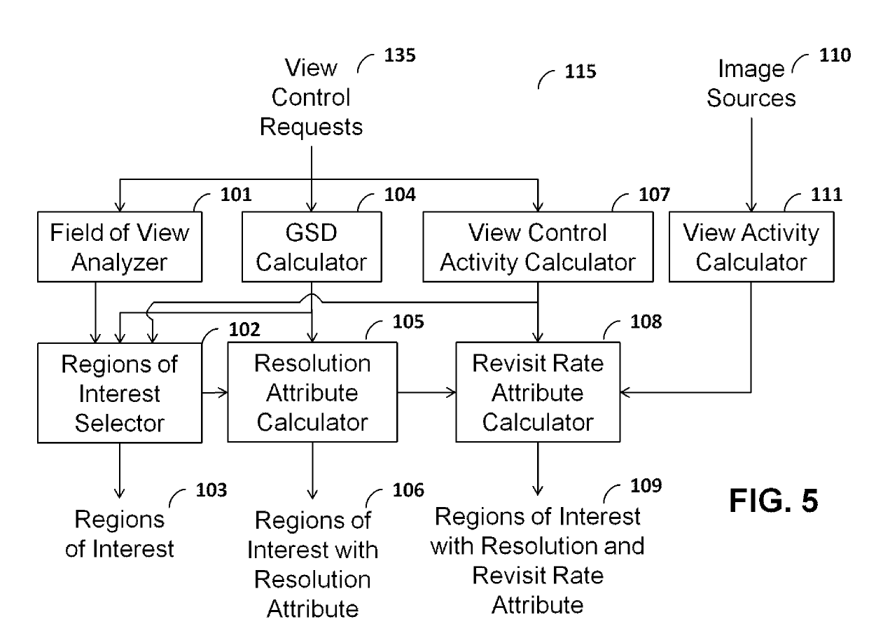

FIG. 5 is a detailed block diagram illustrating an exemplary method 115 that can be implemented in Scan Pattern Generator 100 for adaptively determining a scan pattern for the plurality of image sources based on collective view requirements of the plurality of users. A scan pattern can comprise of a set of regions of interest with each region of interest optionally associated with recommended control attributes such as resolution and revisit rate. Scan Pattern Generator 100 operates on a plurality of view control requests 135 from a plurality of users specifying requested field of view, resolution, view point and view angle. The Field of View Analyzer 101 processes the view control requests 135 to generate a set of regions of interest and associated data sources. In the most basic configuration, this set of regions of interest output as the final Regions of Interest 103. In an alternate configuration, the set of regions of interest are combined into one or more regions of interest.

GSD Calculator 104 is an optional component. It processes the View Control Requests 135 to compute the GSD for each of the requested views. The Regions of Interest Selector 102 can optionally use the GSD calculation to adjust the regions of interest computed by 101 and associate an appropriate Image Source. For example, consider two sources with first low-resolution source with GSD 1 pixel/unit, and second high-resolution source with GSD 0.25 pixel/unit. If a requested view corresponds to a GSD of 2.0 pixel/unit, then Regions of Interest Selector 102 can associate the corresponding region of interest with the low-resolution source alone. If portions of the requested view have a GSD lower than the low-resolution source then the Regions of Interest Selector 102 can split the corresponding region of interest into one or more sub-regions of interest and associate them with appropriate image source based on GSD.

Resolution Attribute Calculator 105 is an optional component. Resolution Attribute Calculator 105 determines the resolution at which a given region of interest maybe captured based on the GSD metric computed by GSD Calculator 104. For example, if a requested view has a GSD requirement of 0.5 pixel/unit, and the associated image source has a GSD of 0.25 pixel/unit, then a resolution attribute of 2×2 reduction factor can be associated with the region of interest.

View Control Activity Calculator 107 is an optional component. View Control Activity Calculator 107 processes the View Control Requests 135 to compute a metric that captures the variability in the field of view, for a view, over time. For example, if a view is fixed, the view control activity metric will be zero and increases as the user starts to control the view. This metric can be used by Regions of Interest Selector 102 to adjust the tightness of the region of interest associated with the view. The larger the view control activity metric, a larger border around the requested field of view can be maintained to minimize frequent changes to the regions of interest.

View Activity Calculator 111 is also an optional component. It processes the imagery to compute a metric that captures visual activity in a view over time. For example, if a view is looking over an empty parking lot, the view activity metric will be zero and increases as the vehicles start to come into the view. The Revisit Rate Attribute Calculator 108 can combine the view activity metric with the view control activity metric to compute a revisit rate attribute to recommend frequency at which the associated region of interest may be visited.

The output of method 115 is thus a scan pattern which comprises of a set of regions of interest with an associated image source and optional one or more of resolution and revisit rate control attributes.

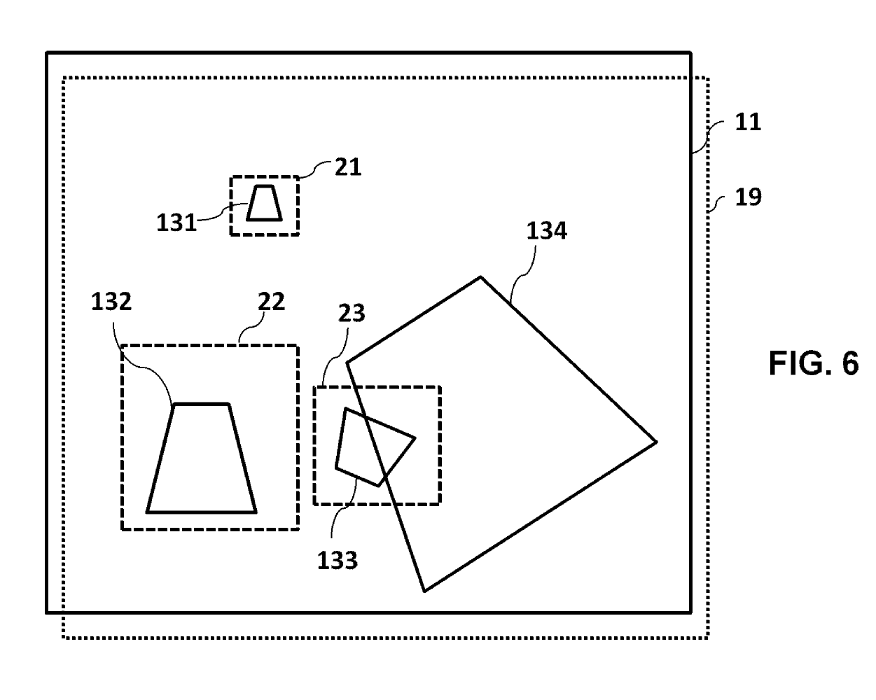

FIG. 6 is a graphic representation illustrating an exemplary behavior for optional exemplary Scan Pattern Generator 100 component of FIG. 2. Scan Pattern Generator 100 processes the view control requests from a plurality of users to adaptively determine a scan pattern for Image Sources 10 and 20. These components can reduce the amount of transfer bandwidth required from the Image Sources 10 and 20 to the computing device 120.

For illustration purposes only, the field of view 11 represents the collective field of regard of Image Sources 10 (not shown) with a resolution of 512×512 pixels. Let the field of regard in ground coordinates be 4096×4096 units. Further, field of view 19 represents the collective overall field of regard of Image Sources 20 (not shown) with a resolution of 4096×4096 pixels. The figure illustrates four respective users 221, 222, 223 and 224 (not shown) with respective view control requests for respective field of views 131, 132, 133 and 134 with respective rectangular dimensions 160×160 units, 640×640 units, 320×320 units and 1280×1280 units. Let the output image size (i.e. display resolution) requirement be 160×160 pixels for all four users. Note, as illustrated, the requested field of views 131, 132, 133 and 134 can have different location, magnification and may even overlap. Since, the output image size is the same, a smaller field of view such as 131 and 133 correspond to a zoomed-in view compared to a view corresponding to field of view 134.

An exemplary output of Scan Pattern Generator 100 is indicated as a set of three regions of interest 21, 22, and 23 for Image Sources 20. Note no region of interest is generated corresponding to field of view 134. This output is explained herein. The required GSD for fields of view 131, 132, 133 and 134 is 1, 0.25, 0.5 and 0.125 pixel/unit, respectively. Image Sources 10 have a GSD of 0.125 pixel/unit, while Image Sources 20 have a GSD of 1 pixel/unit. For fields of view with GSD greater than that of Image Sources 10, such as 131, 132 and 133, Scan Pattern Generator 100 determines that high-resolution imagery is required, while for field of view 134 the GSD is less or equal to that of Image Sources 10, therefore Image Sources 10 is determined to be adequate to meet resolution requirement of view corresponding to 134. This example corresponds to a configuration where components 101, 102 and 104 of FIG. 5 are active.

Scan Pattern Generator 100 can also associate a resolution reduction attribute with each region of interest. For instance, requested field of view 132 has a GSD of 0.25 pixel/unit, while Image Source 20 has a GSD of 1 pixel/unit. Scan Pattern Generator 100 may recommend that region of interest 22 be captured with a resolution reduction by 4×4. Similarly, for field of view 133, the recommended resolution reduction attribute is 2×2. This scenario corresponds to a configuration where components 101, 102, 104 and 106 of FIG. 5 are active.

Scan Pattern Generator 100 can also associate a revisit rate attribute with each region of interest. Scan Pattern Generator 100 can be configured to measure scene and view change activity corresponding to a view. Let the combined activity metric be 10, 20, and 40 for fields of view 131, 132 and 133, respectively. Based on this measurement Scan Pattern Generator 100 can recommend a revisit rate attribute which is a function of the inverse of the activity metric. This scenario corresponds to a configuration where all components 101, 102, 104, 106, 107, 108 and 111 of FIG. 5 are active.

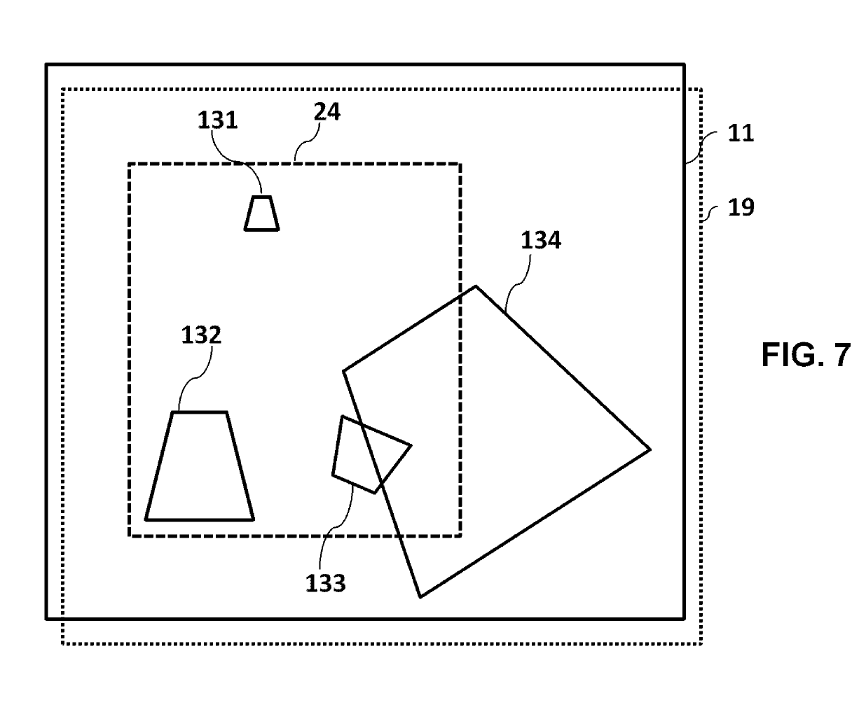

FIG. 7 is a graphic representation illustrating another exemplary behavior for an exemplary Scan Pattern Generator 100 component of FIG. 2. The configuration of Image Sources 10 and 20, their respective fields of view, and configuration of requested field of view and their display resolutions are selected to be the same as in the previous example. An exemplary output of Scan Pattern Generator 100 is indicated as a single region of interest 24, which is a superset of the three fields of view 131, 132, 133 whose GSD requirements exceed that of Image Sources 10. This example corresponds to a configuration where components 101, 102 and 104 of FIG. 5 are active and 102 is configured to take the union of all regions of interest.

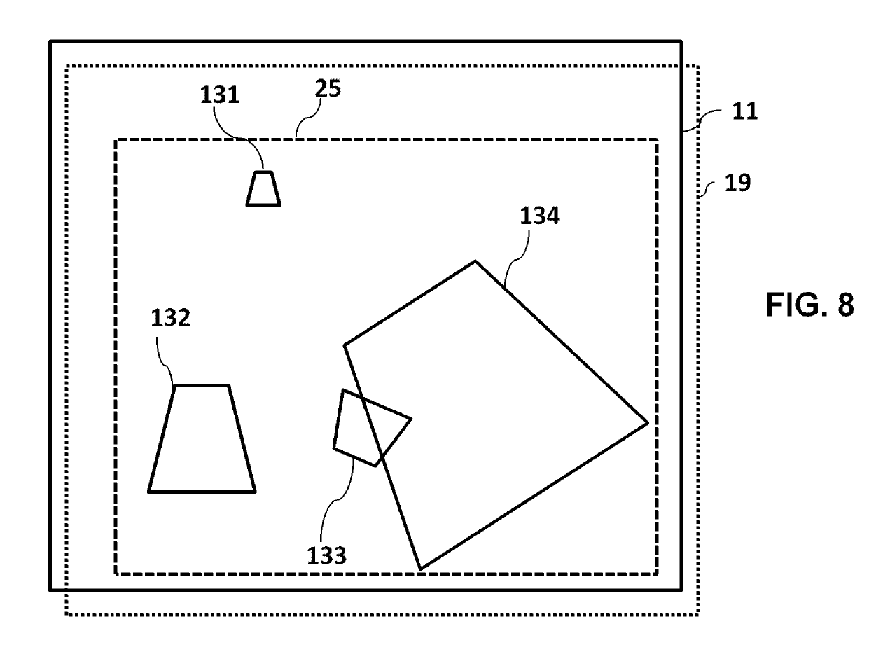

FIG. 8 is a graphic representation illustrating another exemplary behavior for an exemplary Scan Pattern Generator 100 of FIG. 2. The configuration of Image Sources 10 and 20, their respective fields of view, and configuration of requested field of view and their display resolutions are selected to be the same as in the previous example. An exemplary output of Scan Pattern Generator 100 is indicated as a single region of interest 25, which is a superset of all four fields of view 131, 132, 133 and 134. This example corresponds to a configuration where only component 101 and 102 of FIG. 5 are active, and 102 is configured to take the union of all regions of interest.

Image Source Controller 80 of FIG. 2 is an optional component. Image Source Controller 80 is operative on the regions of interest with optional associated control attributes generated by the Scan Pattern Generator 100, and translates them to actual control commands, which are then relayed to Image Sources 10 and 20. For example, let the output of Scan Pattern Generator 100 is a set of two regions of interest, and let Image Sources 20 is a single NTSC PTZ camera. Image Source Controller 80 can control Image Sources 20 to periodically hop between the two regions of interest. The hopping rate and dwell time can be adjusted based on any revisit-rate attributes associated with the regions of interest. In another example, if Image Sources 20 comprised of two PTZ cameras, Image Source Controller 80 can configure the PTZ to dwell on the first region of interest and the other PTZ to dwell on the second region of interest. In another example, if the Image Source 20 is a fixed Prosilica GE4900, Image Source Controller 80 can configure it to alternately output the two regions of interest. It can also configure Image Source 20 to provide a region of interest at a specific resolution, if any resolution reduction attribute has been associated with a region of interest. In another example, if the Image Source 20 is a cluster of two fixed Prosilica GE4900 configured to have adjoining fields of view, and one of the two regions of interest spans the field of view of both of the Prosilica GE4900 cameras. In this example, Image Source Controller 80 can split the region of interest into two sub-regions of interest, one corresponding to the first camera and other corresponding to the second camera of Image Source 20.

1. A system for providing personalized interactive experience of a scene to a plurality of concurrent users comprising:
a) a plurality of image sources;
b) view control input for each of the plurality of users; and
c) View Composer for generating at least two different output views based on the view control input using the plurality of image sources.

2. The system of claim 1 wherein at least one of the plurality of image sources has a larger ground sampling distance compared to the other image sources.

3. The system of claim 1 wherein at least one of the first plurality of image sources has a higher frame rate compared to the other image sources.

4. A method for providing personalized interactive experience of a scene to a plurality of concurrent users comprising:
a) a plurality of image sources;
b) view control input for each of the plurality of users; and
c) View Composer for generating at least two different output views based on the view control input using the plurality of image sources.

5. A system for providing personalized interactive experience of a scene to a plurality of concurrent users comprising:
a) a first plurality of image sources viewing a first portion of a scene with a low quality characteristic and a second plurality of image sources viewing a second portion of a scene with a high quality characteristic;
b) view control input for each of the plurality of users; and
c) View Composer for generating at least two different output views based on the view control input using the first and second plurality of image sources, wherein at least one of the two different output views contains a view of the first portion of the scene synthesized with a high quality characteristic.

6. The system of claim 5 wherein the low quality characteristic corresponds to a low ground sampling distance and the high quality characteristic corresponds to a high ground sampling distance.

7. The system of claim 5 wherein the low quality characteristic corresponds to a low frame rate, and the high quality characteristic corresponds to a high frame rate.

8. A system for providing personalized interactive experience of a scene to a plurality of concurrent users comprising:
a) a plurality of image sources;
b) view control input for each of the plurality of users;
c) Scan Pattern Generator for generating a Scan Pattern that selects regions of interest with control attributes of the plurality of image sources in response to the plurality of view control inputs;
d) Image Source Controller for controlling the image sources in response to the Scan Pattern; and
e) View Composer for generating at least two different views based on the view control input using the plurality of image sources.

9. The system of claim 8 wherein at least one of the plurality of image sources has a high ground sampling distance compared to the other image sources.

10. The system of claim 8 wherein at least one of the plurality of image sources has a high frame rate compared to the other image sources.

11. The system of claim 8 wherein the Scan Pattern includes a set of regions-of-interest corresponding to one or more image sources.

12. The system of claim 8 wherein the Scan Pattern includes a set of regions-of-interest corresponding to one or more image sources and with at least one of revisit rate and resolution control attributes associated with each region of interest.

13. A method for providing personalized interactive experience of a scene to a plurality of concurrent users comprising:
a) a plurality of image sources;
b) view control input for each of the plurality of users;
c) Scan Pattern Generator for generating a Scan Pattern that selects regions of interest with control attributes for the plurality of image sources in response to the plurality of view control inputs;
d) Image Source Controller for controlling the image sources in response to the Scan Pattern; and
e) View Composer for generating at least two different views based on the view control input using the plurality of image sources.

14. A system for providing personalized interactive experience of a scene to a plurality of concurrent users comprising:
a) a first plurality of image sources viewing a first portion of a scene with a low quality characteristic and a second plurality of image sources viewing a second portion of a scene with a high quality characteristic;
b) view control input for each of the plurality of users;
c) Scan Pattern Generator for generating a Scan Pattern that selects regions of interest with control attributes for the plurality of image sources in response to the plurality of view control inputs;
d) Image Source Controller for controlling the image sources in response to the Scan Pattern; and
e) View Composer for generating at least two different output views based on the view control input using the first and second plurality of image sources, wherein at least one of the two different output views contains a view of the first portion of the scene synthesized at a high quality characteristic.

15. The system of claim 14 wherein the Scan Pattern includes a set of regions-of-interest corresponding to one or more image sources.

16. The system of claim 14 wherein the Scan Pattern includes a set of regions-of-interest corresponding to one or more image sources and with at least one of revisit rate and resolution control attributes associated with each region of interest.

17. The system of claim 14 wherein the low quality characteristic corresponds to a low ground sampling distance and the high quality characteristic corresponds to a high ground sampling distance.

18. The system of claim 14 wherein the low quality characteristic corresponds to a low frame rate, and the high quality characteristic corresponds to a high frame rate.

19. A method for providing personalized interactive experience of a scene to a plurality of concurrent users comprising:
a) a first plurality of image sources viewing a first portion of a scene with a low quality characteristic and a second plurality of image sources viewing a second portion of a scene with a high quality characteristic;
b) view control input for each of the plurality of users;
c) Scan Pattern Generator for generating a Scan Pattern that selects regions of interest with control attributes for the plurality of image sources in response to the plurality of view control inputs;
d) Image Source Controller for controlling the image sources in response to the Scan Pattern; and
e) View Composer for generating at least two different output views based on the view control input using the first and second plurality of image sources, wherein at least one of the two different output views contains a view of the first portion of the scene synthesized at a high quality characteristic.
